(19) United States
(12) Patent Application Publication
(10) Pub. No.: US 2021/0107778 A1
(43) Pub. Date: Apr. 15, 2021

(54) Pry Tool

(71) Applicant: William V. Clavelli, The Colony, TX (US)

(72) Inventor: William V. Clavelli, The Colony, TX (US)

(21) Appl. No.: 17/071,874

(22) Filed: Oct. 15, 2020

Related U.S. Application Data
(60) Provisional application No. 62/915,457, filed on Oct. 15, 2019.

(51) Int. Cl. B66F 15/00; B25C 11/00

(52) U.S. Cl. CPC B66F 15/00; B25C 11/00

(57) ABSTRACT

A pry tool is a torque multiplier that allows a normal straight pry bar to be used in situations that require a greater angle of attack or that require changes in that angle of attack. A round body includes multiple pry bar insertion holes extending radially inward and spaced around an arc on a curved rolling surface. A curved jaw extends from the round body, with one face extending tangent-wise from the rolling surface and the other face converging to the first to form a claw at the opposing end.

### REFERENCE TO RELATED INVENTIONS

This application claims priority to pending provisional application Ser. No. 62/915,457 and incorporates that application hereinto in its entirety.

### BACKGROUND OF THE INVENTION

A pry bar is a tool used to apply leverage by taking advantage of length of the arm to apply mechanical advantage. A straight pry bar can limit that advantage a very narrow angle if constrained by free space around its handle. That is, the environment may interfere with the end of the pry bar opposite the point of application to prevent further desirable movement of that opposite end to apply force to the object sought to be moved.

An example: a flat object laying horizontally on the ground. In attempting to lift one side of the object, the acute angle of a straight pry bar limits how much the object can be lifted before the handle hits the ground. This is also a position that may also put strain on the users back and limits the force that can be applied, as the handle is low to the ground.

### SUMMARY OF THE INVENTION

The tool is a torque multiplier that allows a normal straight pry bar to be used in situations that require a greater angle of attack. An embodiment of the invention offers several advantages. First, it allows a user to stand upright while using the pry bar. Second, the design of the head with a curved jaw extending from the round body allows one to lift the object higher with less effort by using the radius of the ball as a lever. Third, the round ball portion with multiple pry bar insertion points also allows the bar to be used in a greater arc than the small end on a straight pry bar would by allowing the lever to take multiple operating angles.

The pry tool generally consists of the body (the ball portion) and the jaw.

The body is generally cylindrical in shape, with flat ends, but joins the jaw along about a part of its face. Along its transverse axis, the body includes a cylindrical void extending from end. Along slightly less than about one-half of its round cylindrical surface, the body includes several rectangular holes extending from the cylindrical face to the void, the holes being shaped to accept the end of a pry bar. The void in the center allow space for the angled end of the pry bar to be effectively locked into the body.

The jaw extends away from the body and then splits to form a claw similar to one commonly found on hammers, with a split open at the far end (away from the body) and narrowing as it approaches the body. In the dimension transverse to the axis, the jaw is broader as it joins the body and narrows (essentially to a point) at the far end. That shape is arcuate, especially on the bottom face, which may join the body at or near to a tangent to permit a smooth transition as one rotates the tool about the body and bottom face (or from the bottom face to the body).

An advantage of the present invention is that one may more easily move around (rotate, slide) an object supported object on the ball-shaped body. In other embodiments, not shown, the body could be flat around the radius or be supported by wheels or rollers to either side for lifting and moving pallets or slabs (such as an axle supported through the void or near the junction of the body and claw.

### BRIEF DESCRIPTION OF THE DRAWINGS

FIG. 1 shows a top view of an embodiment of the present invention.

FIG. 2 shows side view of an embodiment of the present invention.

FIG. 3 shows an isometric view of Section A-A in FIG. 1.

FIG. 4 shows a side view of an embodiment of the present invention being used.

FIG. 5 shows a side view of optional positions for inserting a pry bar into an embodiment of the present invention.

### DETAILED DESCRIPTION

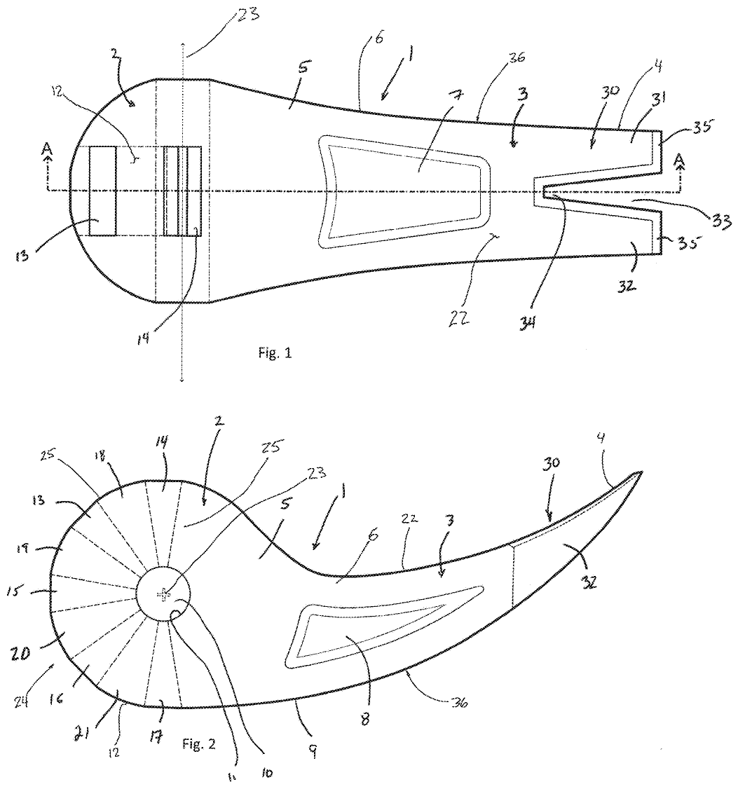

Turning to FIGS. 1-3, in an embodiment, pry tool 1 includes body (or tool body) 2 and jaw 3. Body 2 is generally cylindrical along transverse axis 23 but may narrow as it extends outward along that axis. Body 2 includes cylindrical section 25 and transverse hole or void 10, with cylindrical surface 11, radially-spaced tool holes 13, 14, 15, 16, & 17 which extend from curved surface 12 of body 2 to transverse hole 10. As shown in FIG. 2, tool holes 13-17 are spaced circumferentially around curved surface 12 so that each is along a radius from transverse axis 23 that is spaced angularly from one another. The center-to-center spacing may be 45 degrees with five holes, where the first and last are thus radially-separated by 180 degrees. In other embodiments (not shown) the spacing could be 30 degrees with 7 holes, or 60 degrees with 4 holes, or other values. Curved surface 12 forms arcuate rolling surface 24.

Tool holes 13-17 are shaped to accept a pry bar and may be rectangular in tangent section but narrowing as they travel inward, such that the holes are pyramidal as shown in FIG. 3 Tool holes 13-17 are spaced apart from one another by spacers 18, 19, 20, 21, which are joined to the rest of body 2.

Body 2 also include transition 5, which joins body 2 to jaw 3. In an embodiment, transition 5 extends in a direction parallel to transverse axis 23 from slightly less than about ½ of body 2, roughly along a tangent from body 2. As the radial points of departure are separated by less than 180-degrees on the transition side, the two tangent surfaces are converging (i.e. forming a narrower transition 5 to jaw 3. Those surfaces may also begin tangent but also curve, especially near lower surface 9 (of jaw 3) to form a convex arcuate surface.

In an embodiment, jaw 3 includes convexly curved lower surface 9, lightening features 7 & 8, and claw assembly 30, forming prying end 36. Jaw 3 joins to transition 5 at its proximal end 6 and then further extends away from body 2 toward distal end 4. In an embodiment, jaw 3 has lower convex surface 9 opposing arcuate concave surface 22 on its upper side. This causes jaw 3 to become narrower as it extends away from body 2. Lightening features 7 may appear on, respectively, the sides and upper side of jaw 3. Jaw 3 ends on distal end 4 at claw assembly 30, which includes right and left arms 31, 32, each of which end in chisel tip 35. Between arms 31, 32 is groove 33 which is open between tips 35 but narrows as it approaches transition 5.

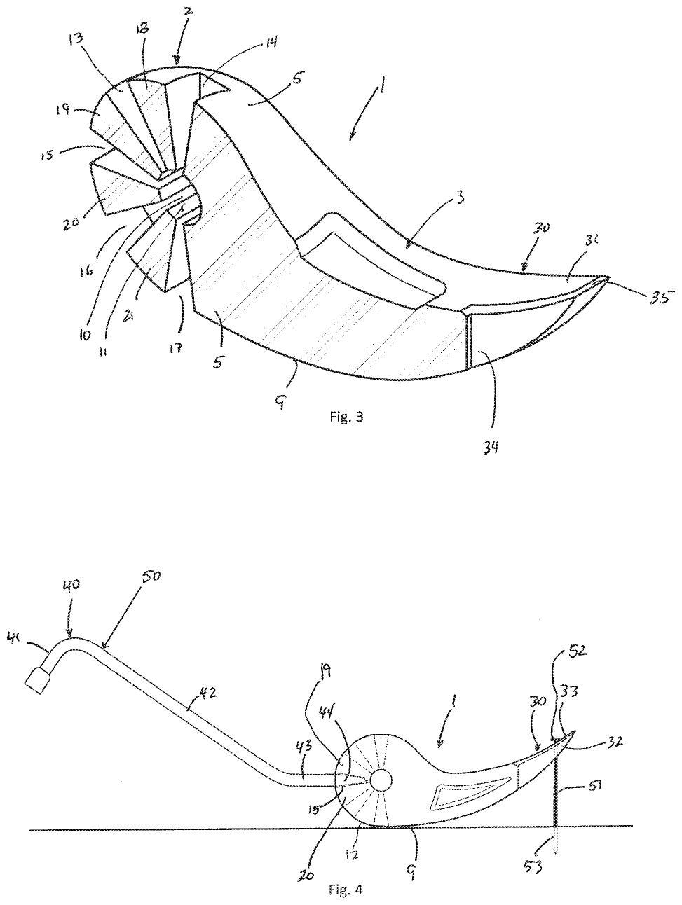

Convex arcuate lower surface 9 connects to rolling surface 24 of curved surface 12 smoothly, preferably with those surfaces being tangent thereto at the connection. This is to permit a smooth transition as one rotates pry tool 1 (e.g. as shown in FIG. 4).

Turning to FIG. 4, in an embodiment, pry tool 1 is used with pry bar 40, which includes handle 41 connected to arm 42 connected to end 43 and pointed tip 44. Tip 44 is inserted into one of tool holes 13-17 (here, 15) and force 50 applied to cause pry tool 1 to rotated downward at body 2 and upward at jaw 3 (and claw 30). Applying force 50 at the distance of arm 42 and end 43 creates an additional lever arm to amplify a lifting force applied to claw 30. Claw 30 (in this embodiment) has head 52 of nail 51 trapped in groove 33 to pull tip 53 of nail 51 out of the substrate below.

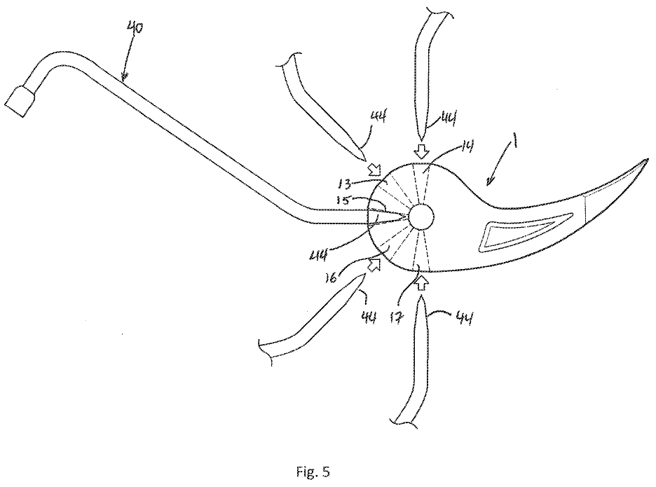

Turning to FIG. 5, tip 44 of pry bar 40 can be inserted into any of the tool holes 13-17. The selection of the appropriate hole will be guided by the option giving the best leverage and considerations such as clearance. For instance, in FIG. 3, tip 44 of pry bar 40 might originally have been placed in tool hole 16 when claw assembly 30 was near to the ground, then moved to tool hole 15 as nail 51 was pulled out, and might then later be moved to tool hole 13 as handle 41 gets too close to the ground for either convenience, clearance, or best leverage.

1. A pry tool for use with a pry bar, the pry tool comprising:
a tool body;
said tool body having a transverse axis; and
said tool body comprising at least two narrowing tool holes;
said tool holes configured to receive torque from a pry bar; and
the tool holes separated circumferentially about said transverse axis from one another; and
a prying end;
said prying end rigidly connected to the tool body.

2. The pry tool of claim 1,
the tool body further comprising three or more narrowing tool holes.

3. The pry tool of claim 2,
at least two of said four or more narrowing tool holes separated by about 180 degrees from one another.

4. The pry tool of claim 2,
the tool body further comprising five narrowing tool holes;
wherein two of said four or more narrowing tool holes are separated by about 180 degrees from one another.

5. The pry tool of claim 1,
the tool body further comprising
a roughly cylindrical section into which said narrowing tool holes extend radially inward; and
a void formed along the transverse axis thereof.

6. The pry tool of claim 1,
the tool body further comprising an arcuate rolling surface.

7. The pry tool of claim 6,
wherein said at least two tool holes extend through said arcuate rolling surface.

8. The pry tool of claim 6,
the prying end comprising a lower arcuate surface;
wherein said lower arcuate surface is smoothly connected to said arcuate rolling surface.

9. The pry tool of claim 1,
the prying end comprising a proximal end and a distal end; and
wherein said prying end is connected at its proximal end to the tool body; and
said prying end comprises a claw at its distal end.

10. The pry tool of claim 1,
the prying end comprising a proximal end, a distal end, an upper concave surface, and a lower convex surface;
wherein said upper concave surface and lower convex surface converge at the distal end; and
wherein said prying end is connected at its proximal end to the tool body.

11. The pry tool of claim 1,
the tool body further comprising
a roughly cylindrical section into which said narrowing tool holes extend radially inward;
a rolling surface on said roughly cylindrical section; and
the prying end comprising a convex surface;
wherein said convex surface is smoothly connected to said rolling surface.

12. The pry tool of claim 1,
the tool body further comprising
five narrowing tool holes; and
a rolling surface; and
the prying end comprising a convex surface;
wherein said convex surface is smoothly connected to said rolling surface.

13. The pry tool of claim 1,
said narrowing tool holes having a rectangular cross-section.

14. The pry tool of claim 1,
the tool body further comprising a curved rolling surface; and
the prying end comprising a lower arcuate surface;
wherein said lower arcuate surface joins said curved rolling surface at a tangent thereto.

15. A method of applying leverage, comprising:
inserting a pry bar into a first narrowing tool hole formed in a tool body;
said tool body comprising a second narrowing tool hole separated circumferentially about a transverse axis on said body from said first narrowing tool hole;
applying torque to said tool body;
rotating said tool body;
applying a lifting force to a prying end rigidly connected to the tool body.

16. The method of applying leverage of claim 15, further comprising
removing the pry bar from the first narrowing tool hole; and
inserting said pry bar into said second narrowing tool hole.

17. The method of applying leverage of claim 15, further comprising
said rotating step comprising rotating said tool body on a curved rolling surface on the exterior thereof.

18. The method of applying leverage of claim 17, further comprising
said rotating step further comprising rotating said tool body on a lower arcuate surface of said prying end.
